(19) United States
(12) Patent Application Publication
(10) Pub. No.: US 2009/0116128 A1
(43) Pub. Date: May 7, 2009

(54) Viewing device

(75) Inventor: Paul Meyer, Cambridge (GB)

Correspondence Address: OSHA LIANG L.L.P., TWO HOUSTON CENTER, 909 FANNIN, SUITE 3500, HOUSTON, TX, 77010, US

(73) Assignee: Cambridge Enterprise Limited, Cambridge, Cambridgeshire (GB)

(21) Appl. No.: 11/913,050

(22) PCT Filed: May 2, 2006
(86) PCT No.: PCT/GB06/01597

§ 371 Date: May 28, 2008

(30) Foreign Application Priority Data
Apr. 29, 2005 (GB) 0508834.9

(51) Int. Cl. G02B 7/04; G02B 7/06

(52) U.S. Cl. 359/811; 359/480

(57) ABSTRACT

A viewing device comprises: a pair of optically aligned lenses which are moveable relative to each other to vary the gap between facing surfaces of the lenses, and a linkage for controlling the relative motion. The linkage includes first and second elongate members which crossover each other at a crossover pivot connection. The first elongate member extends between a slidably moveable pivot connection which is arranged to transmit relative motion to the first lens of the pair and a pivot connection which is arranged to transmit relative motion to the second lens of the pair. The second elongate member extends between a slidably moveable pivot connection which is arranged to transmit relative motion to the second lens and a pivot connection which is arranged to transmit relative motion to the first lens. The connections are arranged such that the linkage can open and close in a concertina- or scissor-like fashion.

The present invention relates to viewing devices with optically aligned lenses and particularly but not exclusively devices such as spectacles.

Many optical devices with multiple lenses require variable separation of the lenses from each other or the image plane when focusing, magnifying or altering other characteristics of the image. Uniocular devices can focus objects at varying distances using mechanical devices such as threads, slides or telescopic tubes. Binocular devices require two pairs of lenses to be adjusted identically and simultaneously.

Binoculars usually consist of a pair of telescopic tubes which are made to slide simultaneously and move by an identical distance. This is achieved by a screw that is placed between the tubes and drives both sides of the system simultaneously.

Adjustable binocular systems have been applied to spectacles to improve the viewing experience of the user. For example, GB Patent No. 14,716 proposes an adjustable binocular system, in which the bows of a front pair of spectacles slide in sleeve portions on a rear pair of spectacles. As the bows of the front pair of spectacles slide along the sleeves, the separation between the two pairs of spectacles varies.

The binocular glasses of U.S. Pat. No. 3,420,599 incorporate two adjustable levers pivotally connected to a front spectacle frame which are also connected to a thread on a rear spectacle frame via threaded sleeves. Rotation of the thread moves the levers and varies the separation between the two frames.

In WO 03/083556 a gear wheel and roller mechanism is used to adjust the distance between nested lenses in a pair of spectacles. Failing accommodation of the eye to view objects at varying distances (presbyopia) can be compensated with the spectacles by making such adjustments.

Since most tasks (e.g. preparing a meal, reading music on a stand, undertaking machine work or viewing plans) require focusing of various object planes, a device for correcting the failing accommodation should be adjustable to examine any distance from the normal near point to infinity. A mechanism that allows constant and easy adjustment of the separation of the lenses (particularly, simultaneous and identical adjustments for both eyes) would enhance the usability of such a viewing device.

Many aids for the visually disabled also require simultaneous separation of two pairs of spectacle lenses.

Accordingly, the present invention provides a viewing device comprising:
a pair of optically aligned (i.e. substantially coaxial) lenses which are moveable relative to each other to vary the gap between facing surfaces of the lenses, and
a linkage for controlling the relative motion, the linkage including first and second elongate members which crossover each other at a crossover pivot connection, the first elongate member extending between a slidably moveable pivot connection which is arranged to transmit relative motion to the first lens of the pair and a pivot connection which is arranged to transmit relative motion to the second lens of the pair, and the second elongate member extending between a slidably moveable pivot connection which is arranged to transmit relative motion to the second lens and a pivot connection which is arranged to transmit relative motion to the first lens;
wherein the connections are arranged such that the linkage can open and close in a concertina- or scissor-like fashion.

With such a viewing device it is possible to move one of the lenses of the pair and cause relative motion between it and the other lens. The linkage formed by the elongate members and the connections allows continuous and easy adjustments to be made to change the separation between the first and second lens so that objects can be viewed at different distances. However, at the same time, the linkage can provide precise control over the relative positions of the lenses to maintain, for example, optical alignment.

In general, the lenses will be held in respective supports. Each connection transmitting relative motion to the first lens can then be to a respective point on the support of that lens. Similarly, each connection transmitting relative motion to the second lens can be to a respective point on the support of that lens. Thus the connections may be arranged to transmit controlled relative motion to the lenses via the supports. However, in other embodiments, the connections may be made directly to the lenses. Alternatively, the connections may transmit the relative motion via other intermediary bodies in addition to or instead of the supports.

The position of the crossover pivot connection may be moveable along one of the elongate members such that the optical axis of one of the lenses can be tilted or angled with respect to the optical axis of the other lens. Such tilt can be useful, for example, to correct for astigmatism or to introduce a progressive (typically top to bottom) varifocal effect. For additional adjustability, the position of the crossover pivot connection may be moveable along both of the elongate members.

In general, the pivot connection transmitting relative motion to the first lens directly faces the pivot connection transmitting relative motion to the second lens across the gap between the lenses. Furthermore, the two slidably moveable pivot connections generally face each other in the same way. However, in some embodiments the connections may be offset so that they do not face across the gap. Such an arrangement also allows variable tilt or angulation between the optical axes of the lenses to be introduced.

The elongate members of the linkage may be spaced apart at the crossover connection to provide the linkage with additional structural rigidity. Other embodiments of the viewing device have a second linkage that is in a different plane from the plane of the crossed elongate members of the first linkage. The second linkage may have a similar construction to the first linkage. The second linkage provides increased structural rigidity whilst still permitting the varying separation between the first and second lenses. The structural rigidity of the viewing device can be increased further if the plane of residence of the second linkage is substantially orthogonal to that of the first linkage.

The viewing device may have an actuator mechanism for moving the lenses relative to each other. The actuator mechanism may be operated by hand and may be in the form of a screw, cam or any other means for moving the first and second lenses apart or displacing the slidable pivots. The actuator mechanism allows the user to vary the separation between the lenses without fouling the lenses. Furthermore, the actuator mechanism may be motorised, electronic, pneumatic, hydraulic or operated by any other automatic means to move the two lenses. The mechanism may not act on the lenses directly, but rather may act on e.g. lens supports or parts of the linkage.

Preferably the viewing device further comprises a second pair of optically aligned and relatively moveable lenses. A binocular system such as this allows the device to be used on spectacles, binoculars, loupes, binocular camera systems, etc. Indeed, the viewing device is not limited to only two pairs of lenses. Linkages may be applied to more than two lenses in a lens group and more than two lens groups along the same or different optical axes. The term “lens group” defines a lens structure with two or more optical elements aligned along an optical path. Furthermore, in binocular viewing systems that include more than two optical elements in the two lens groups, suitable adaptation of the linkage structure may allow each lens to be separated differentially. For example, the linkage may have further crossed elongate members in addition to the first and second elongate members that accommodate further optical elements and extend the linkage, for example, in the manner of a lazy-tong.

Preferably the second pair of lenses is spaced from the first pair of lenses such that a user can look through one pair of lenses with one eye while looking through the other pair of lenses with the other eye.

One linkage may control the relative motions of both pairs but preferably each pair of optically aligned lenses has a respective linkage for controlling the relative motion.

The respective linkages may be openable and closeable independently of each other whereby the lens separation within one of the pairs of lenses may be altered independently of the lens separation within the other. For example, since both eyes are not typically identical in the normal human subject, the correction required for each pair of lenses may be different.

However, the respective linkages may be cooperatively arranged such that opening or closing one of the linkages results in corresponding movement from the other of the linkages.

A cooperative arrangement may vary the angle between the respective axes of the pairs of lenses as the linkages open or close. In the normal human subject, the optical pathways of the two eyes are not parallel and angle inwards during accommodation to intersect at the object. Thus it is useful for the viewing device to correspondingly adjust the angle between the axes.

The viewing device may further comprise an alteration means for altering the spacing between the pairs of lenses. This is particularly useful when the device may have to be adapted to the eye spacing of different users.

Preferably the viewing device is a pair of spectacles, for example, spectacles to treat medical conditions of the eye such as presbyopia, myopia, hypermetropia and astigmatism.

The invention will now be described by way of example with reference to the accompanying drawings, wherein:

FIGS. 1a and 1b are schematic plan views of a first embodiment of the invention in the closed and open positions respectively,

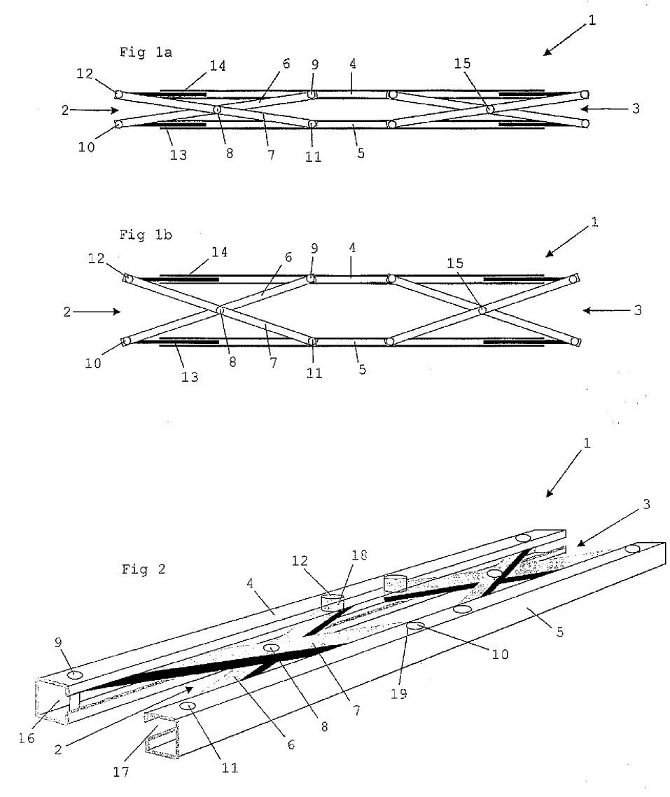

FIG. 2 is a schematic perspective view of a second embodiment of the invention,

FIG. 3 is a schematic side elevation of a third embodiment,

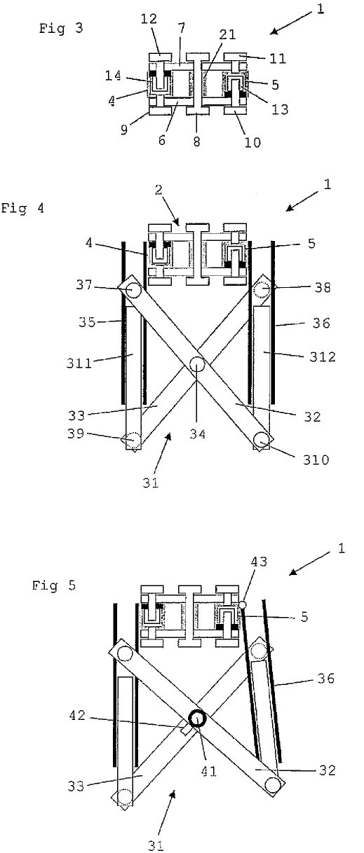

FIG. 4 is a schematic side elevation of a fourth embodiment,

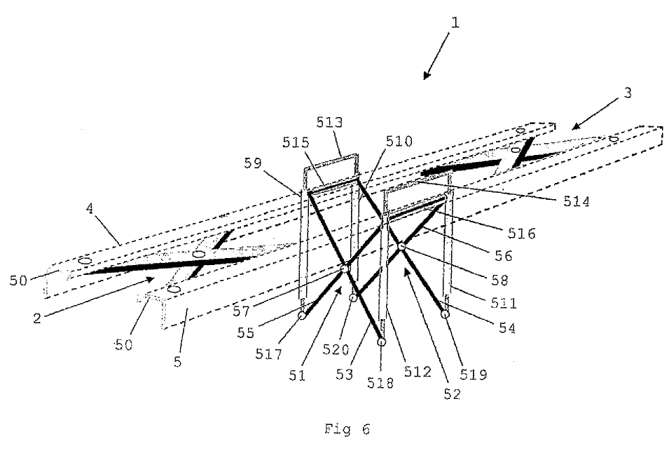

FIG. 5 is a schematic side elevation of a fifth embodiment,

FIG. 6 is a schematic perspective view of a sixth embodiment,

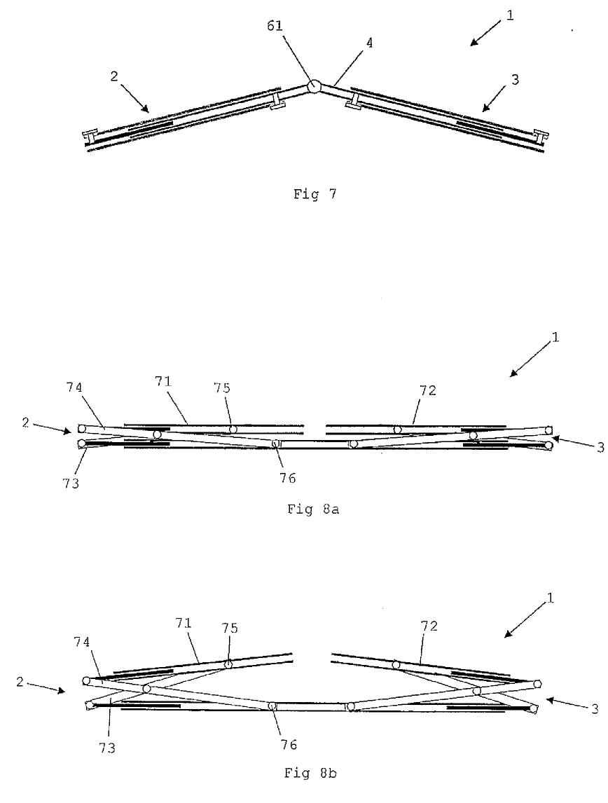

FIG. 7 is a schematic front sectional elevation of a seventh embodiment,

FIGS. 8a and 8b are schematic plan views of an eighth embodiment in the closed and open positions respectively,

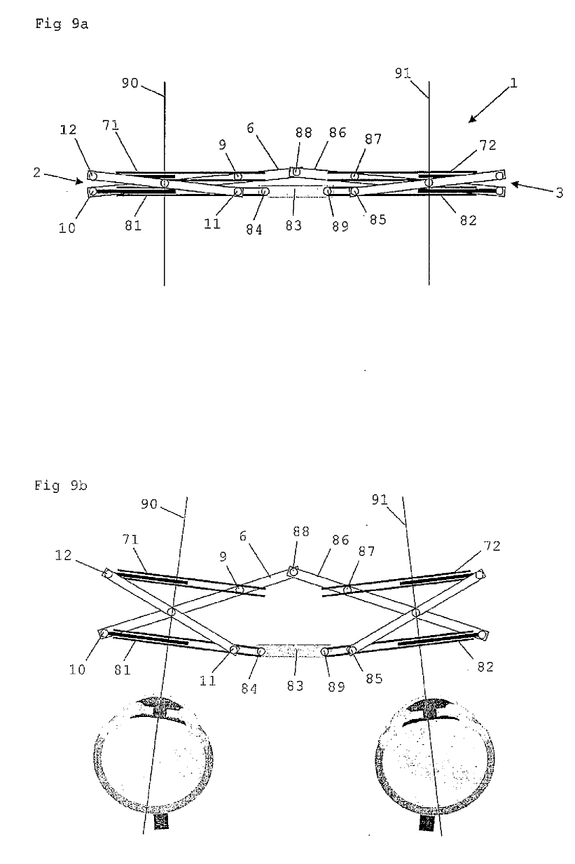

FIGS. 9a and 9b are schematic plan views of a ninth embodiment in the closed and open positions respectively, and

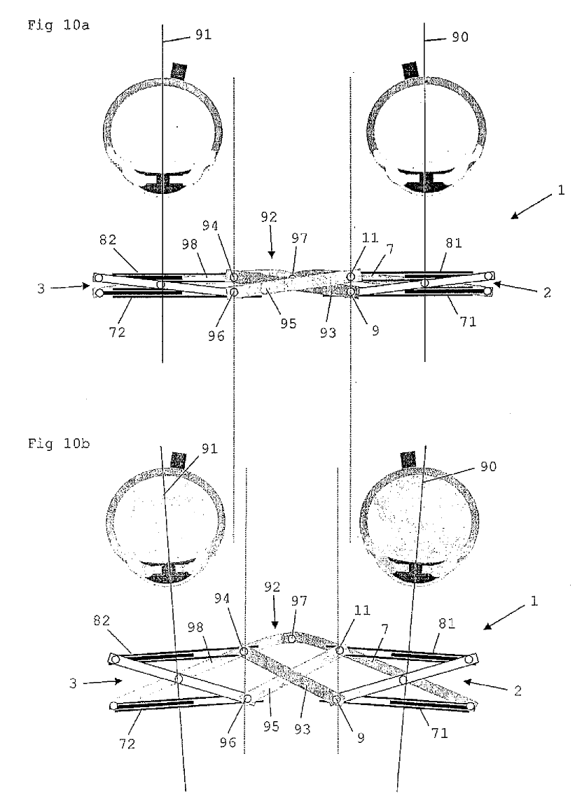

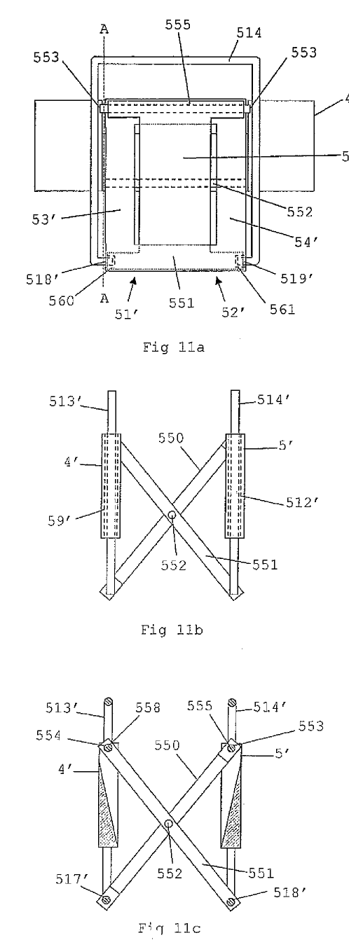

FIGS. 10a and 10b are schematic plan views of a tenth embodiment in the closed and open positions respectively, and

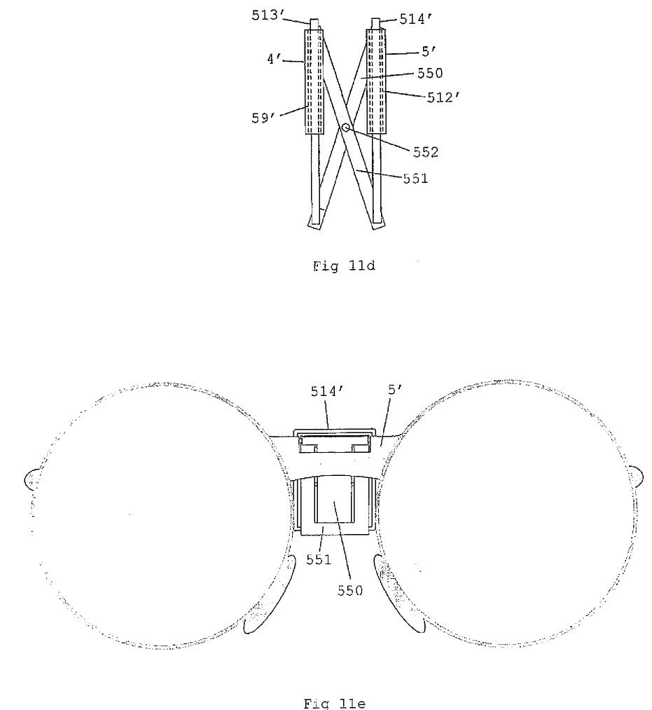

FIGS. 11a, 11b and 11c are schematic front, side and cross-sectional views respectively of an eleventh embodiment in the open position, FIG. 11d is a schematic side view of the eleventh embodiment in the closed position, and FIG. 11e is a further front view of the eleventh embodiment in the closed position in use on a pair of spectacles.

FIG. 1a shows a schematic plan view of a first embodiment of a frame 1 for a pair of spectacles in a closed position. The frame 1 has two linkages 2, 3 attached to a rear support crossbar 4 and to a front support crossbar 5. For clarity, the lenses and the other parts of the frame of the spectacles (such as the side arms) are not shown. However, each support crossbar would support left and right lenses, the left lens of the rear support crossbar 4 being optically aligned with the left lens of the front support crossbar 5 to form a lens pair, and the right lenses of the support crossbars forming a similar lens pair. Thus linkage 2 controls the relative motion between the lenses of the left pair and linkage 3 controls the relative motion between the lenses of the right pair.

Linkage 2 is formed from two intersecting elongate members 6, 7 which are pivotally moveable relative to each other at crossover pivot connection 8. The first elongate member 6 has a pivot connection 9 at the rear support crossbar 4 and a slidably moveable pivot connection 10 at the front support crossbar 5. The second elongate member 7 has a pivot connection 11 at the front support crossbar 5 and a slidably moveable pivot connection 12 at the rear support crossbar 4. The connections permit relative motion to be transmitted to the front and rear lenses of the left and right lens pairs. Linkage 3 is the mirror image of linkage 2, and therefore, the parts of linkage 3 have not been discussed in detail.

The sliding movement of connections 10, 12 is effected by slides 13, 14 which respectively attach the elongate members 6, 7 to the ends of the rear and front support crossbars 4, 5. Support crossbars 4, 5 have a hollow box cross-section, and the slides 13, 14 move inside the crossbars 4, 5 along their longitudinal axes when the linkages extend.

FIG. 1b shows another schematic plan view of the first embodiment with the frame 1 in an open position. When the rear support crossbar 4 is moved away from the front support crossbar 5, the linkages 2, 3 control the relative motion between the lenses of the left and right pairs. The elongate members 6, 7 (i) move pivotally relative to support crossbars 4, 5 at the pivot connections 9, 11, (ii) move pivotally relative to the slides 13, 14 at slidably moveable pivot connections 10, 12, and (iii) move pivotally relative to each other at pivot crossover connection 8. The relative pivotal motion of the elongate members 6, 7 with respect to the support crossbars 4, 5 causes the slides 13, 14 to move along the longitudinal axis of the support crossbars towards the centre of the support crossbars 4, 5. The overall effect is concertina- or scissor-like opening of the linkages.

Thus the linkages 2, 3 force the support crossbars 4, 5 to remain parallel and hence the front and rear lenses of each lens pair remain optically aligned during and after the frame adjustment. The linkages control the movement of the support crossbars and control the lens separation within each lens pair. Advantageously, motion produced at any point on a support crossbar 4, 5 results in identical motion of the rest of the crossbar.

FIG. 2 shows a perspective view which is a variant of the frame 1 of FIG. 1. The same reference numbers are used for equivalent features between FIGS. 1 and 2.

In the second embodiment, linkage 2 has first and second elongate members 6, 7 which are now fixed by pivot connections 9, 11 at the ends of the rear and front support crossbars 4, 5, and the slidably moveable pivot connections 10, 12 reside towards the centre of the rear and front support crossbars 4, 5.

Cylindrical slides 18, 19 carry the slidably moveable pivot connections and reside in respective channels 16, 17 formed within the support crossbars 4, 5. Thus as slides 18, 19 move along the channels 16, 17, the elongate members 6, 7 move pivotally relative to the slides and the crossbars. The second embodiment provides the additional advantage that the device is more compact since the slidably moveable connections do not protrude beyond the ends of the crossbars.

FIG. 3 shows a side elevation of a third embodiment of the invention. This embodiment is the same as the first embodiment except that the inside opposing faces of the first and second elongate members 6, 7 are spaced apart by a spacer 21 surrounding crossover pivot connection 8. This arrangement ensures that the first and second elongate members 6, 7 are moveable in spaced, parallel planes. The third embodiment has increased structural rigidity and the linkages have additional resistance to twisting forces.

FIG. 4 shows a side elevation of a fourth embodiment in accordance with the invention. The fourth embodiment combines the third embodiment with a second linkage for providing increased structural rigidity. The second linkage permits controlled relative motion between the front and rear optically aligned lenses of each lens pairs. The plane of residence of the second linkage 31 is different, and typically orthogonal, to the plane of residence of the first linkages 2, 3. Typically, the first linkages are in a horizontal plane, and the second linkage is in a vertical plane.

The second linkage 31 is of similar construction to the first linkages 2, 3. It has first and second elongate members 32, 33 connected by a crossover pivot connection 34. The first elongate member 32 is attached to a rear strut 35 extending perpendicularly from the rear support crossbar 4. The second elongate member 33 is attached to a front strut 36 extending perpendicularly from the front support crossbar 5. The first elongate member 32 has a pivot connection 37 at the rear strut 35 and slidably moveable pivot connection 310 at the front strut 36. The second elongate member 33 has a pivot connection 38 at the front strut 36 and slidably moveable pivot connection 39 at the rear strut 35. The struts 35, 36 can provide support for the lenses of the right and/or left lens pairs.

The slide movement of connections 39, 310 is effected by slides 311, 312 in a similar fashion to the sliding movement in the first linkages. Thus as the separation of the rear and front support crossbars 4, 5 varies, the movement of the second linkage provides controlled separation between the front and rear lenses of each lens pair. However, the second linkage ensures that the lenses remain in a plane orthogonal to the plane in which the crossed elongate members of the first linkages 2, 3 reside.

A fifth embodiment of the invention, as shown in FIG. 5, incorporates the features of the fourth embodiment and further permits the face of one of the lenses of a pair to be tilted with respect to the face of the other lens of the pair. With reference to WO 03/083556, this can provide a progressive varifocal correction, i.e. the focal length of the lens system shortens from top to bottom, allowing nearer objects to be viewed during down-gaze.

The second linkage 31 has first and second intersecting elongate members 32, 33 that are connected by a slidably moveable pivot crossover connection 41. At their intersection, the second elongate member 33 has a slot 42 in which the slidably moveable pivot crossover connection 41 can move along the second elongate member 33. The front orthogonal strut 36 is attached by a pivot 43 to the front support crossbar 5. When the position of the slidably moveable pivot crossover connection 41 is adjusted, the front orthogonal strut 36 rotates about pivot connection 43 and the angle between the optical axis of the front lens changes with respect to the optical axis of the rear lens.

A sixth embodiment, as shown in FIG. 6, incorporates the fourth embodiment and provides improved structural rigidity to the spectacles by using two, joined together, second linkages instead of one. Again, the second linkages are in a different (typically orthogonal) plane to the plane of the first linkages. The connections of the additional second linkage are similar to the second linkage in the fourth embodiment. For clarity, the support bars 4, 5 are shown in FIG. 6 with intermittent lines.

The arrangement of the connections of the first linkages 2, 3 is the same as the second embodiment. However, the support crossbars 4, 5 are cut away and their cross section forms an “L” shape to provide space at their centres to attach the second linkages 51, 52. Thus the slides (not shown) carrying the slidably moveable pivot connections (not shown) move in the centre of the support crossbars 4, 5 in a shallow channel 50.

The rear and front support crossbars 4, 5 have tubular elements 59, 510, 511, 512 extending perpendicularly to the plane of residence of the crossed elongate members of the first linkages 2, 3.

The tubular elements 59, 510, 511, 512 accommodate respective arms of two inverted U-shaped portions 513, 514. The second linkages 51, 52 are joined i) in their pivot connections with the rear and front support crossbars 4, 5 via sleeve portions 515, 516 and ii) in the inverted U-shaped portions 513, 514 at the ends of which they make slidably moveable pivot connections 517, 518, 519, 520.

When the separation between support crossbars 4, 5 varies, the elongate members 53, 55 of second linkage 51 and the elongate members 54, 56 of second linkage 52 pivot relative to each other at respective crossover pivot connections 57, 58 (structurally, elongate members 53 and 54 are the arms of one U-shaped rod whose central section extends through sleeve portion 515, and elongate members 55 and 56 are the arms of another U-shaped rod whose central section extends through sleeve portion 516). The sliding movement of the connections 517, 518, 519, 520 is accomplished by the arms of inverted U-shaped portions 513, 514 moving in the tubular elements 59, 510, 511, 512. Thus, as the two support crossbars 4, 5 move towards each other, the slidably moveable pivot connections 517, 518, 519 520 permit relative pivotal motion between the “U” portions and the elongate members. Hence, the slidably moveable pivot connections 517, 518, 519, 520 move down so that the middle sections of the U-shaped portions 513, 514 approach or meet the support crossbars 4, 5.

The sixth embodiment of the spectacle frames shown in FIG. 6 provides further structural rigidity whilst allowing controlled relative movement of the front and rear lenses of the left and right lens pairs. Optionally, the first linkages 2, 3 may be omitted, as the central assembly formed by the second linkages 51, 52 can provide sufficient rigidity on its own to maintain the lenses in their appropriate relative positions.

In addition, the tubular elements 59, 510, 511, 512 can be used to support the lenses. When a user wears the spectacles the U-shaped portions 513, 514 bridge the user's nose.

FIG. 7 shows a front sectional elevation of a seventh embodiment that is a variant of the first embodiment. The seventh embodiment allows the spacing between the lens pairs to be altered to accommodate for eye spacing of different users by having a stiff central pivot 61 in support crossbars 4, 5. However, by angling crossbars 4, 5 at pivot 61, linkages 2 and 3 adopt different planes of residence, which gives further stability to the lenses in the vertical plane.

FIG. 8a shows an eighth embodiment of the invention in a closed position. This embodiment allows the independent relative movement of the lenses of the pairs.

The frame 1 has a first front support bar 71 and a second front support bar 72 that replace the front support crossbar in the first embodiment. Moreover, the first and second elongate members 73, 74 of the first linkage 2 are of different lengths and are pivotally moveable at connections 75, 76 which are offset so that they do not face each other across the gap between the respective pair.

FIG. 8b shows the eighth embodiment in the open position. The effect is similar to that achieved by the sliding of the pivot connection 41 in the fifth embodiment, i.e. the angle between the optical axes of the lenses is varied, although the angular variation is now in a different plane and is achieved by a different mechanism. The other of the first linkages 3 is a mirror image of the first linkage 2. Minor adjustments to the geometry of the linkages allow the angle between the optical axes to change as a function of the separation within each lens pair. Thus, the frame 1 allows the controlled independent relative movement of each lens pair relative to the other lens pair. Of course, if each connection was exactly opposite its corresponding connection on the facing crossbar, independent motion of the two linkages would be achieved, while the lenses of each pair remained parallel.

A ninth embodiment of the invention is shown in FIGS. 9a and 9b. By connecting the two first linkages 2, 3 cooperative convergence of the two optical axes is achieved.

The frame 1 has a first linkage 2 that is connected between a first front support bar 71 and a first rear support bar 81 and the other first linkage 3 is connected between a second front support bar 72 and a second rear support bar 82. The first and second rear bars 81, 82 are fixed to a third rear bar 83 by pivot connections 84, 89. The arrangement of the connections 9, 11, 10, 12 is the same as the first embodiment. However, the first elongate member 6 of the first linkage 2 and the second elongate member 86 of the other first linkage 3 extend beyond the pivot connections 9, 87 to meet at crossover pivot connection 88.

FIG. 9a shows the frame 1 in the closed position where the respective axes 90, 91 of the lens pairs are parallel. As the front bars 71, 72 are separated from the rear bars 81, 82, the rear bars 81, 82 move about pivot connections 84, 89 on the third bar 83. Thus the two first linkages 2, 3 move pivotally relative to each other about connections 84, 88, 89 so that the axes 90, 91 converge at a point in front of the user as shown in FIG. 9b. However within the pairs of lenses, the front and back lenses remain aligned and parallel and the inter-lens spacing is adjusted by an identical amount.

FIGS. 10a and 10b show a tenth embodiment of the invention providing an alternative method of cooperatively converging the axes of the lens pairs. Whereas crossover pivot connection 88 between elongate members of adjacent linkages faces away from the user in the ninth embodiment, the corresponding connection 97 faces towards the user in the tenth embodiment. Furthermore, the front bars 71, 72 and the rear bars 81, 82 are connected by cross braces 92. The first brace 93 of cross braces 92 is connected to the pivot connection 9 on the first front bar 71, and to the pivot connection 94 on the second rear bar 82. The second brace 95 of cross braces 92 is connected to the pivot connection 11 on the first rear bar 81 and to the pivot connection 96 on the second front bar 72. The second elongate member 7 of the first linkage 2 and the first elongate member 98 of the second linkage 3 extend beyond the respective pivot connections 94, 11 to meet at crossover pivot connection 97.

As the frame 1 moves from the closed position in FIG. 10a to the open position in FIG. 10b, the angle between the axes 90, 91 changes such that they converge to a point in front of the user. Furthermore, as the separation within the lens pairs increases, the angle between braces 95, 93 changes, reducing the distance between the pivot connections on the front bars 9 and 96 (and between the connections on the rear bars 11 and 94 to a lesser extent) and thus the distance between the two pairs of lenses. This reduction of the distance between the lenses is advantageous, as it allows the axes 90, 91 to remain centred on the user's eyes.

FIGS. 11a, 11b and 11c are schematic front, side and cross-sectional views respectively of an eleventh embodiment in the open position. The cross-section of FIG. 11c is along line A-A of FIG. 11a.

This embodiment has two, side-by-side and joined together linkages 51′, 52′ which have similarities with the joined together second linkages 51, 52 of the sixth embodiment described above in relation to FIG. 6. Thus linkage 51′ has a first elongate member 53′ with a lower front, slidably moveable pivot connection 518′ and linkage 52′ has a first elongate member 54′ with a lower front, slidably moveable pivot connection 519′. However, structural rigidity is improved by forming the first elongate members 53′ and 54′ as the opposing sides of a planar rectangular body 551, the body having a central hole.

The structural rigidity is further improved by forming the other elongate members of linkages 51′, 52′ as a unitary, planar, central body 550 which penetrates the central hole of rectangular body 551.

A pin 552 traverses central body 550 and the opposing sides of rectangular body 551 to form the crossover pivot connections of the two linkages.

Two inverted U-shaped portions 513′, 514′ perform effectively the same functions as inverted U-shaped portions 513, 514 of the sixth embodiment, cylindrical holes 512′ (only one being visible in the view of FIG. 11b) in which the arms of the inverted U-shaped portion 514′ are slidable being formed in front plate 5′, and cylindrical holes 59′ (only one being visible in the view of FIG. 11b) in which the arms of the inverted U-shaped portion 513′ are slidable being formed in facing rear plate 4′. These holes correspond to tubular elements 59, 510, 511, 512 of the sixth embodiment. In FIG. 11a, front plate 5′ is omitted for clarity.

The lower front, slidably moveable pivot connections 518′, 519′ are formed by turning in the ends of the arms of the inverted U-shaped portion 514′ and engaging the ends with corresponding recesses 560, 561 in rectangular body 551. Likewise, lower rear, slidably moveable pivot connections 517′ (only one being visible in the view of FIG. 11c) are formed to either side of central member 550 by turning in the ends of the arms of the inverted U-shaped portion 513′ and engaging the ends with corresponding recesses in central member 550. More particularly, central body 550 is I-shaped, the recesses being formed in the ends of the lower portion (hidden behind rectangular body 551, but indicated with dotted lines in FIG. 11a) of the I.

Respective upper, front pivot connections 553 of the linkages 51′, 52′ are formed by pin 555 which extends across the upper portion of the I-shaped central body 550 to fit into corresponding recesses in front plate 5′. Similarly, respective upper, rear pivot connections 554 (only one being visible in the view of FIG. 11c) of the linkages 51′, 52′ are formed by pin 558 which extends across the top side of rectangular body 551 to fit into corresponding recesses in rear plate 4′.

FIG. 11d is a schematic side view of the eleventh embodiment in the closed position. Front plate 5′ and rear plate 4′ have tapered central portions (shown in the cross-sectional view of FIG. 11c) which accommodate central body 550 and rectangular body 551 in the closed position.

FIG. 11e is a further front view of the eleventh embodiment in the closed position in use on a pair of spectacles.

Conveniently, the rear 4′ and front 5′ plates in which the arms of the inverted U-shaped portions 513′, 514′ are slidable being adapted to form the bridge of the spectacles.

The viewing device of the present invention is particularly adapted for adjusting the nested lenses described in WO 03/083556. Thus the optically aligned lenses of the present invention may provide a lens structure in which:
The or each pair of optically aligned lenses are nested such that the gap between the facing surfaces of the lenses is a cleft of variable width, one of the lenses having a divergent refracting surface and the other having a convergent refracting surface.
The maximum width of the cleft may be less than the focal length of the refracting surface of the first of the lenses through which viewed light travels, and preferably the maximum width of the cleft is less than one half or one quarter of this focal length.
One of the lenses may have a concave surface within which nests a convex surface of the other of the lenses, the cleft being created between said surfaces.
The lenses may be arranged so that viewed light travels through the concave and convex surfaces in that order.
The facing surfaces of the lenses may have complementary shapes so that when they are brought into precise juxtaposition, the cleft between them is virtually eliminated.
The refracting surfaces may be of substantially equal and opposite focusing power.
Both of the outer lens surfaces may be substantially planar.

1. A viewing device comprising:
a pair of optically aligned lenses which are moveable relative to each other to vary the gap between facing surfaces of the lenses, and
a linkage for controlling the relative motion, the linkage including first and second elongate members which crossover each other at a crossover pivot connection, the first elongate member extending between a slidably moveable pivot connection which is arranged to transmit relative motion to the first lens of the pair and a pivot connection which is arranged to transmit relative motion to the second lens of the pair, and the second elongate member extending between a slidably moveable pivot connection which is arranged to transmit relative motion to the second lens and a pivot connection which is arranged to transmit relative motion to the first lens;
wherein the connections are arranged such that the linkage can open and close in a concertina- or scissor-like fashion.

2. A viewing device according to claim 1, wherein the position of the crossover connection is moveable along at least one of the elongate members to tilt one of the lenses relative to the other lens.

3. A viewing device according to claim 1, further comprising a second linkage for controlling the relative motion, the crossed elongate members of the second linkage residing in a different plane from the crossed elongate members of the first linkage.

4. A viewing device according to claim 3, wherein the plane of residence of the crossed elongate members of the second linkage is substantially orthogonal to the plane of residence of the crossed elongate members of the first linkage.

5. A viewing device according to claim 1, further comprising an actuator mechanism for moving the lenses relative to each other.

6. A viewing device according to claim 1, further comprising a second pair of optically aligned and relatively moveable lenses.

7. A viewing device according to claim 6, wherein the second pair of lenses are spaced from the first pair of lenses such that a user can look through one pair of lenses with one eye while looking through the other pair of lenses with the other eye.

8. A viewing device according to claim 6, wherein each pair of optically aligned lenses has a respective linkage for controlling the relative motion.

9. A viewing device according to claim 8, wherein the respective linkages are openable and closable independently of each other.

10. A viewing device according to claim 9, wherein the respective linkages are cooperatively arranged such that opening or closing one of the linkages results in corresponding movement from the other of the linkages.

11. A viewing device according to claim 10, wherein the cooperative arrangement varies the angle between the respective axes of the pairs of lenses as the linkages open or close.

12. A viewing device according to claim 6, further comprising alteration means for altering the spacing between the pairs of lenses.

13. A viewing device according to claim 6, which is a pair of spectacles.

14. (canceled)

15. (canceled)

16. The viewing device of claim 1, which is a hand-held optical instrument such as a pair of binoculars.

17. The viewing device of claim 1, which is a laboratory optical instrument, such as a microscope and preferably a binocular microscope.
